(19) United States
(12) Patent Application Publication
(10) Pub. No.: US 2006/0224927 A1
(43) Pub. Date: Oct. 5, 2006

(54) Security detection system and methods regarding the same

(75) Inventors: George Wang, Chongqing (CN); Ji Yun Huang, Chongqing (CN)

Correspondence Address: ARENT FOX PLLC, 1050 CONNECTICUT AVENUE, N.W., SUITE 400, WASHINGTON, DC, 20036, US

(73) Assignee: FarStone Tech, Inc.

(21) Appl. No.: 11/387,767

(22) Filed: Mar. 24, 2006

(30) Foreign Application Priority Data
Mar. 24, 2005 (TW) 94109263

(51) Int. Cl. G06F 11/00

(52) U.S. Cl. 714/38

(57) ABSTRACT

A security detection system is installed in a computer system. The security detection system comprises a monitoring module and a message database. The monitoring module is used for monitoring a change operation to the computer system. The message database is used for storing message for the change operation. The monitoring module monitors whether or not the computer system is being infected by virus, spyware, Trojan or other security threats, in accordance with the stored message, so as to enhance the efficiency, which can also improve protective capability.

### CROSS-REFERENCE TO RELATED APPLICATIONS

This is a 35 U.S.C. § 119 of Taiwan Application No. 94109263 filed Mar. 24, 2005. The disclosure of the prior application(s) is hereby incorporated by reference herein in its entirety.

### BACKGROUND OF THE INVENTION

1. Field of the Invention

The present invention relates generally to a security detection technique for a computer system, and more particularly to a security detection system and method that efficiently scans for viruses, Trojan and spyware.

2. Description of Prior Art

Conventional Antivirus (AV) programs protect a computer system from viruses by using a scanning engine. The scanning engine identifies virus-laden files using virus signature files: a unique string of bytes that identifies the virus like a fingerprint. They view patterns in the data and compare them to traits of known viruses captured in the wild to determine if a file is infected, and in most cases are able to strip the infection from files, leaving them undamaged. When repairs aren't possible, antivirus programs will quarantine the file to prevent accidental infection, or can be set up to delete the file immediately.

In the case of new viruses for which no antidote has been created, some engines also use heuristic scanning. This allows the AV programs to flag suspicious data structures or unusual virus-like activity even when there is no matching virus definition. If the program sees any funny business, it quarantines the questionable program and broadcasts a warning to you about what the program may be trying to do (such as modify your Windows Registry). The accuracy of such methods is much lower however, and often a program with this running may err on the side of caution. This can result in confusing false positive results.

In U.S. Pat. No. 5,502,815, entitled “Method and apparatus for increasing the speed at which computer viruses are detected”, initial state information concerning the file or volume is stored. This information is being examined for a virus and when files are subsequently scanned for viruses, the current state information is compared to the initial state information stored in the cache. If the initial state information differs from the current state information then the file or volume is scanned for viruses which change the state information of the file or volume. If the initial state information and current state information is the same then the file or volume is scanned for a subset of viruses which do not change the state information. The teaching of Cozza is incorporated herein by reference to the extent they do not conflict herewith.

However, the patent has one major drawback. That is every subsequent scan process of the file or volume needs to get the current state information and the initial state information stored in the cache. For this reason, speed performance is not very good.

### SUMMARY OF THE INVENTION

The present invention provides a security detection system and method to resolve the foregoing problems faced by the conventional backup/recovery software. The present invention also has the advantage of eliminating unnecessary, repeat scanning.

An object of the present invention is to provide a security detection system and method, which can scan file and sector, to achieve the highest completeness and protection.

Another object of the present invention is to provide a security detection system and method, which can compare version of scanning engine, in order to substantially raise the accuracy.

In accordance with an aspect of the present invention, a security detection system is installed in a computer system. The security detection system comprises a monitoring module and a message database. The monitoring module is used for monitoring a change operation to the computer system. The message database is used for storing message for the change operation. The monitoring module monitors whether or not the computer system is being infected by virus, spyware, Trojan or other security threats, in accordance with the stored message.

In the preferred embodiment of the invention, the security detection system further comprises a scanning module for scanning sector which is being changed and monitored by the monitoring module in accordance with the stored message. The message database stores message for the scanning result. The security detection system further comprises a tag for tagging scanned sectors contained in a partition. The scanned message comprises message for the scanned sectors and version of the scanning module. The security detection system further comprises a scanning module for scanning file which is being changed and monitored by the monitoring module in accordance with the stored message. The message database stores message for the scanning result. The security detection system further comprises a tag for tagging scanned files contained in a partition. The scanned message comprises message for the scanned files and version of the scanning module.

In accordance with another aspect of the present invention, another security detection system is installed in a computer system. The security detection system comprises a monitoring module and a message database. The monitoring module is used for monitoring a scan operation to the computer system. The message database is used for storing message for the scan operation. The monitoring module monitors whether or not the computer system is being infected by virus, spyware, Trojan or other security threats, in accordance with the stored message.

In the preferred embodiment of the invention, the message database stores message for the scanning result of a scanned sector. The security detection system further comprises a scanning module for scanning sector which has not been scanned in accordance with the stored message. The security detection system further comprises a tag for tagging scanned sectors contained in a partition. The scanned message comprises message for the scanned sectors and version of the scanning module. The message database stores message for the scanning result of a scanned file. The security detection system further comprises a scanning module for scanning file which has not been scanned in accordance with the stored message. The security detection system further comprises a tag for tagging scanned files contained in a partition. The scanned message comprises message for the scanned files and version of the scanning module.

The present invention may best be understood through the following description with reference to the accompanying drawings, in which:

### BRIEF DESCRIPTION OF THE DRAWINGS

FIG. 1 shows a schematic block diagram of a security detection system of a preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new technique for a security detection system to scan only the changed sectors or files, which can increasing the scanning speed. With the technique of the present invention, the version of the scanning engine can be compared.

According to the preferred embodiment of the present invention, a security detection system is installed in a computer system. The security detection system comprises a monitoring module and a message database. The monitoring module is used for monitoring a change operation to the computer system. The message database is used for storing message for the change operation. The monitoring module monitors whether or not the computer system is being infected by virus, spyware, Trojan or other security threats, in accordance with the stored message.

The security detection system further comprises a scanning module for scanning sector which is being changed and monitored by the monitoring module in accordance with the stored message. The message database stores message for the scanning result. The security detection system further comprises a tag for tagging scanned sectors contained in a partition. The scanned message comprises message for the scanned sectors and version of the scanning module. The security detection system further comprises a scanning module for scanning file which is being changed and monitored by the monitoring module in accordance with the stored message. The message database stores message for the scanning result. The security detection system further comprises a tag for tagging scanned files contained in a partition. The scanned message comprises message for the scanned files and version of the scanning module.

According to the preferred embodiment of the present invention, there is another security detection system is installed in a computer system. The security detection system comprises a monitoring module and a message database. The monitoring module is used for monitoring a scan operation to the computer system. The message database is used for storing message for the scan operation. The monitoring module monitors whether or not the computer system is being infected by virus, spyware, Trojan or other security threats, in accordance with the stored message.

The message database stores message for the scanning result of a scanned sector. The security detection system further comprises a scanning module for scanning sector which has not been scanned in accordance with the stored message. The security detection system further comprises a tag for tagging scanned sectors contained in a partition. The scanned message comprises message for the scanned sectors and version of the scanning module. The message database stores message for the scanning result of a scanned file. The security detection system further comprises a scanning module for scanning file which has not been scanned in accordance with the stored message. The security detection system further comprises a tag for tagging scanned files contained in a partition. The scanned message comprises message for the scanned files and version of the scanning module.

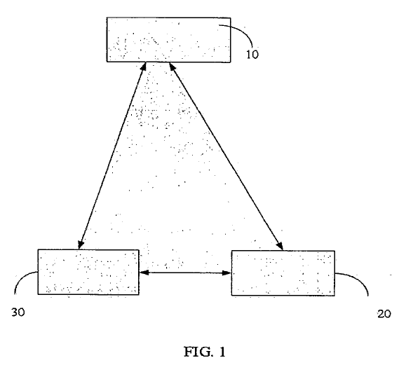

Referring to FIG. 1, a schematic block diagram of a security detection system of a preferred embodiment according to the present invention is shown. The security detection system of the present invention is suitable for a computer system. The security detection system includes at least a monitored area 10, a monitoring module 20 and a message database 30.

The monitored area 10 may be an entire HD or at least a partition. The monitored area 10 may contain a number of files or sectors. The monitoring module 20 is used for monitoring a change operation to the monitored area 10. The change operation may be creating a file, renaming a file, changing path of a file or a write operation to a file.

The monitoring module 20 may include a scanning module. The scanning module is used for scanning file or sector to determine if the computer system is infected by virus, spyware, Trojan or other security threats. The message database 30 is used for storing message for the change operation.

In accordance with the stored message, the scanning module scans file or sector which is being changed and monitored by the monitoring module. Then the scanning result is stored in the message database 30. In accordance with the stored message for the scanning result, the monitoring module 20 monitors whether or not the monitored area 10 is being infected by virus, spyware, Trojan or other security threats.

The security detection system further comprises a tag for tagging scanned files or sectors contained in the monitored area 10. The scanned message comprises message for the scanned files/sectors and version of the scanning module. Thus, the scanning module will be updated afterwards and guarantee a newest scanning module to accurately identify security threats.

There is a chance that during the scan operation some of the files/sectors were not scanned owing to the interruption operated by the user. The monitoring module 20 can also be used for monitoring a scan operation to the monitored area 10. The message database 30 can be used for storing message for the scanning result of a scanned sector/file. If some sector/file has not been scanned in accordance with the scanning result, then the file or sector is to be scanned for viruses.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A security detection system, which is installed in a computer system, said security detection system comprising:
a monitoring module for monitoring a change operation to said computer system; and
a message database for storing message for said change operation; wherein
said monitoring module monitors whether or not said computer system is being infected by virus, spyware, Trojan or other security threats, in accordance with said stored message.

2. The security detection system according to claim 1, further comprising a scanning module for scanning sector which is being changed and monitored by said monitoring module in accordance with said stored message.

3. The security detection system according to claim 2, wherein said message database stores message for said scanning result.

4. The security detection system according to claim 3, further comprising a tag for tagging scanned sectors contained in a partition.

5. The security detection system according to claim 4, wherein said scanned message comprises message for said scanned sectors and version of said scanning module.

6. The security detection system according to claim 1, further comprising a scanning module for scanning file which is being changed and monitored by said monitoring module in accordance with said stored message.

7. The security detection system according to claim 6, wherein said message database stores message for said scanning result.

8. The security detection system according to claim 7, further comprising a tag for tagging scanned files contained in a partition.

9. The security detection system according to claim 8, wherein said scanned message comprises message for said scanned files and version of said scanning module.

10. A security detection system, which is installed in a computer system, said security detection system comprising:
a monitoring module for monitoring a scan operation to said computer system; and
a message database for storing message for said scan operation; wherein
said monitoring module monitors whether or not said computer system is being infected by virus, spyware, Trojan or other security threats, in accordance with said stored message.

11. The security detection system according to claim 10, wherein said message database stores message for said scanning result of a scanned sector.

12. The security detection system according to claim 11, further comprising a scanning module for scanning sector which has not been scanned in accordance with said stored message.

13. The security detection system according to claim 11, further comprising a tag for tagging scanned sectors contained in a partition.

14. The security detection system according to claim 11, wherein said scanned message comprises message for said scanned sectors and version of said scanning module.

15. The security detection system according to claim 10, wherein said message database stores message for said scanning result of a scanned file.

16. The security detection system according to claim 15 further comprising a scanning module for scanning file which has not been scanned in accordance with said stored message.

17. The security detection system according to claim 15, further comprising a tag for tagging scanned files contained in a partition.

18. The security detection system according to claim 15, wherein said scanned message comprises message for said scanned files and version of said scanning module.
